(19) United States
(12) Patent Application Publication
(10) Pub. No.: US 2015/0189050 A1
(43) Pub. Date: Jul. 2, 2015

(54) Mobile phone structure capable of selectively mounting a camera lens

(71) Applicant: Tau-Jeng Hsu, Shenzhen (CN)

(72) Inventor: Tau-Jeng Hsu, Shenzhen (CN)

(21) Appl. No.: 14/142,969

(22) Filed: Dec. 30, 2013

(51) Int. Cl. H04M 1/02; G02B 13/02; H04N 5/225; G02B 13/00

(52) U.S. Cl. CPC H04M 1/0264; G02B 13/0015; G02B 13/02; H04N 5/2254

(57) ABSTRACT

A mobile phone structure includes a housing and an optical assembly. The housing defines a substantially inverted cone-shaped recess at its bottom that accommodates therein a CMOS image sensor being electrically connected to a control board within the housing. The optical assembly can be constructed of a wide-angle lens module for providing a wider angle of view, a telephoto lens module for bringing distant objects closer, a close-up lens module for monitoring miniature objects, or a filtering module for reducing undesired light. The mobile phone structure allows a user to select a specific optical assembly and mount it into the recess of the housing according to an application requirement. As such, the photographing or videoing function of the mobile phone structure can be significantly increased.

### BACKGROUND OF THE INVENTION

1. Field of the Invention The invention relates to a mobile phone structure and, more particularly, to a mobile phone structure that can be selectively and releasably mounted with a specific optical assembly to meet a user's need.

2. Description of Related Art

Currently, the built-in cameras of the existing mobile phones are installed at their backs and in flush with the back surfaces. Although the CMOS (complementary metal-oxide-semiconductor) image sensors of the built-in cameras of the existing mobile phones have the advantages of lower power consumption, small volume, and easy integration with the peripheral circuits thereof, the optical lenses of the built-in cameras, which have a fixed focal length, are permanently mounted to the mobile phones, namely that the existing mobile phones cannot change the focal length of the associated built-in cameras for enlarging or reducing the views. Therefore, when an application requires a wider angle of view, a telephoto view, a close-up view, or a filter for reducing ambient light, a user should carry a separate high-level professional camera, which is usually heavy and large, in addition to the mobile phones.

Although the exiting mobile phones may be installed with additional lens mounts through external adapters for achieving those functions, the additional lens mounts and external adapters are large and will protrude from the mobile phones after installing them, and this may cause inconvenience in holding the mobile phones to take photographs and putting the mobile phones into the pockets of the user's clothes. In view of the foregoing, there is a need to provide a mobile phone structure that can be selectively mounted with an optical lens to facilitate the operation of taking photographs, and the optical lens will not protrude from the mobile phone structure after mounting the optical lens.

### SUMMARY OF THE INVENTION

The primary object of the invention is to provide a mobile phone structure that can be selectively and releasably mounted with a specific optical assembly to meet a user's need.

The secondary object of the invention is to provide a mobile phone structure that can be carried by the user more conveniently.

To achieve the above objects, the mobile phone structure may comprise a housing and an optical assembly, wherein the housing defines a substantially inverted cone-shaped recess at its bottom that accommodates therein a CMOS image sensor being electrically connected to a control board within the housing. The optical assembly can be selectively and releasably mounted into the inverted cone-shaped recess corresponding to the CMOS image sensor. The optical assembly can be constructed of a wide-angle lens module for providing a wider angle of view, a telephoto lens module for bringing distant objects closer, a close-up lens module for monitoring miniature objects, or a filtering module for reducing undesired light.

Other objects, advantages, and novel features of the invention will become more apparent from the following detailed description when taken in conjunction with the accompanying drawings.

### BRIEF DESCRIPTION OF THE DRAWINGS

FIG. 1 shows an exploded view of one embodiment of the invention.

FIG. 2 shows an assembled view of the embodiment of the invention.

FIG. 3 shows a sectional view of the embodiment of the invention, wherein the optical assembly is taken from the housing of the mobile phone structure.

FIG. 4 shows another sectional view of the embodiment of the invention, wherein the optical assembly is mounted into the housing of the mobile phone structure.

### DETAILED DESCRIPTION OF THE INVENTION

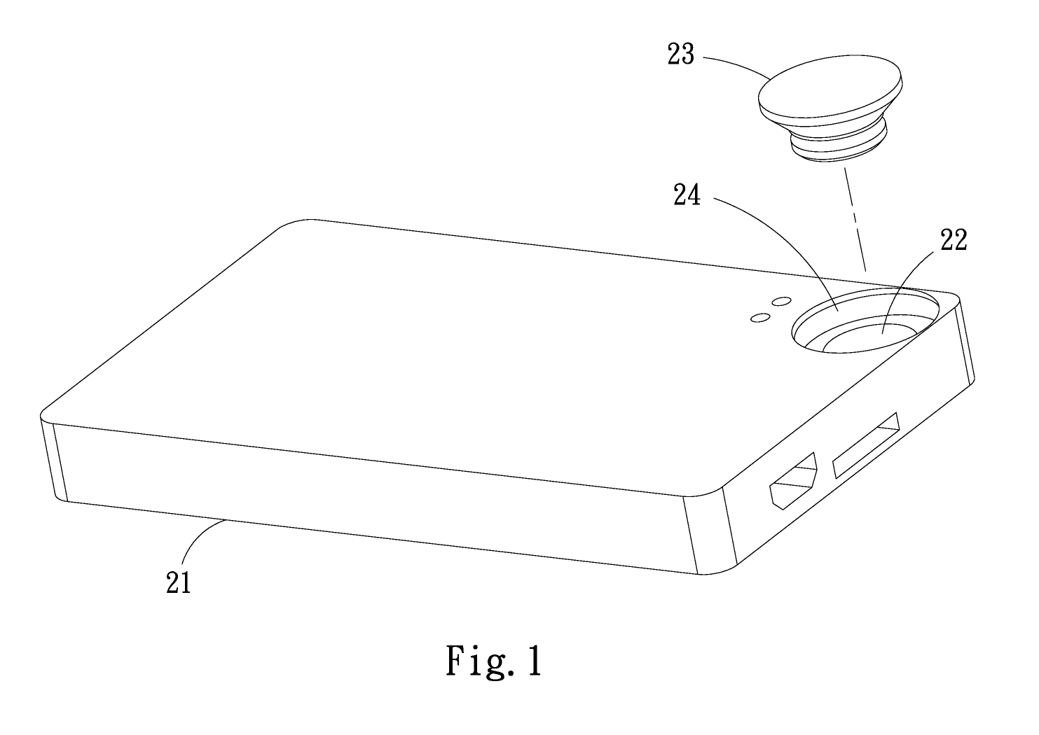

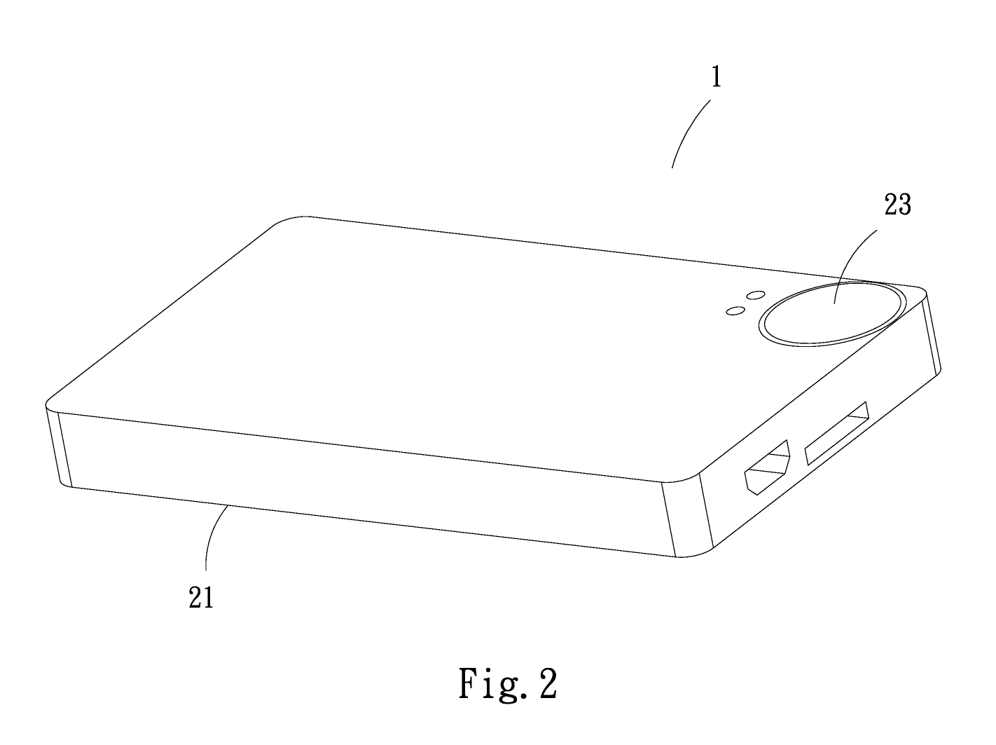

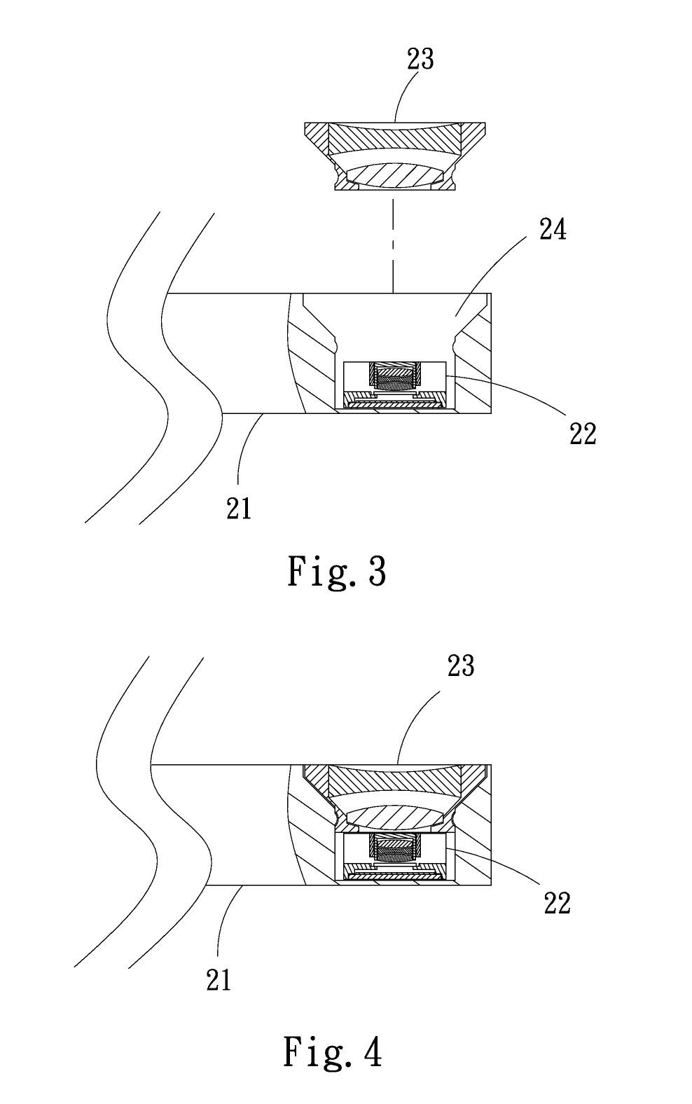

One embodiment of the invention, concerning a mobile phone structure, is shown in FIGS. 1 through 4, wherein the mobile phone structure 1 generally comprises a housing 21 and an optical assembly 23. The housing 21 defines a substantially inverted cone-shaped recess 24 at its back that accommodates therein a CMOS image sensor 22 being electrically connected to a control board (not shown) within the housing 21. Preferably, the CMOS image sensor 22 is located at an innermost part of the recess 24. The optical assembly 23 is selectively and releasably mounted into the inverted cone-shaped recess 24, corresponding to the CMOS image sensor 22, to allow the optical assembly 23 to be in flush with the back surface of the housing 21 after mounting the assembly. The optical assembly 23 can be constructed of a wide-angle lens module for providing a wider angle of view, a telephoto lens module for bringing distant objects closer, a close-up lens module for monitoring miniature objects, or a filtering module for reducing undesired light.

The invention makes use of the mobile's limited space to allow the CMOS image sensor 22 to be properly located within the housing 21, and to allow the CMOS image sensor 22 to be cooperated with various types of optical assemblies, each with a specific high-level optical lens module, for obtaining a desired viewing effect. After mounting the optical assembly 23 into the recess 24, the optical assembly 23 can be located in flush with the back surface of the housing 21. A user can select an optical assembly with a specific optical feature, such as standard viewing, wide-angle viewing, telephoto viewing, close-up viewing, light attenuation and the like, according to a practical requirement, to allow the photographing or videoing function of the mobile phone to be significantly increased.

Furthermore, since the optical assembly 23 is small, light and easy to store, a user can carry several optical assemblies of various functions or factors easily and conveniently. Each optical assembly can be entirely mounted into the inverted cone-shaped recess 24 to allow the top surface thereof to be in flush with the back surface of the housing 21 of the mobile phone. As such, when a user puts the mobile phone of the invention into the pockets of the user' trousers, since there is no object protruding from the housing 21 of the mobile phone structure 1, the user will not feel uncomfortable.

Although the invention has been described with a certain degree of particularity, it is understood that the present disclosure is made by way of example only and the combination and arrangement of parts may be resorted to without departing from the spirit and scope of the invention hereinafter claimed.

What is claimed is:

1. A mobile phone structure, comprising:
a housing and an optical assembly;
wherein the housing defines a substantially inverted cone-shaped recess at its bottom that accommodates therein a CMOS image sensor being electrically connected to a control board within the housing;
wherein the optical assembly is selectively and releasably mounted into the inverted cone-shaped recess corresponding to the CMOS image sensor; and
wherein the optical assembly is constructed of a wide-angle lens module for providing a wider angle of view, a telephoto lens module for bringing distant objects closer, a close-up lens module for monitoring miniature objects, or a filtering module for reducing undesired light.
